(19) United States
(12) Patent Application Publication
(10) Pub. No.: US 2025/0249448 A1
(43) Pub. Date: Aug. 7, 2025

(54) A MICROFLUDIC SYSTEM

(71) Applicant: miDiagnostics NV, Heverlee (BE)

(72) Inventor: David Mikaelian, Heverlee (BE)

(21) Appl. No.: 18/854,957

(22) PCT Filed: Apr. 5, 2023
(86) PCT No.: PCT/EP2023/059029

§ 371 Date: Oct. 7, 2024

(30) Foreign Application Priority Data
Apr. 8, 2022 (EP) 22167374.2

(51) Int. Cl. B01L 3/00

(52) U.S. Cl. CPC B01L 3/502715; B01L 2200/0605; B01L 2200/0642; B01L 2200/0684; B01L 2300/0654; B01L 2300/0867; B01L 2400/0406; B01L 2400/0622

(57) ABSTRACT

The present disclosure relates to a microfluidic system and a method for diluting a sample liquid having a predetermined volume. The present disclosure further relates to a diagnostic device comprising the microfluidic system. An example system comprises: a sample inlet; a first sample channel connecting the sample inlet and a first valve; a second sample channel connecting the first valve and a capillary pump; a sample metering channel having a first end connected to a second valve and a second end connected to a third valve, wherein the first valve is connected to the sample metering channel between the first end and the second end. The system further comprises: a buffer inlet; a first buffer channel connecting the buffer inlet and the second valve; an outlet channel connected to the third valve; and a second buffer channel connecting the second valve and the third valve.

### CROSS-REFERENCE TO RELATED APPLICATIONS

This application is a U.S. national stage application under 35 U.S.C. 371 of International Application No. PCT/EP2023/059029, filed Apr. 5, 2023, which claims priority to and the benefit of European Application No. EP 22167374.2, filed Apr. 8, 2022, the contents of which are incorporated into the present application by reference in their entireties.

### TECHNICAL FIELD

The present disclosure relates to a microfluidic system for diluting a sample liquid having a predetermined volume. The present disclosure further relates to a method for diluting a sample liquid having a predetermined volume, and yet further to a diagnostic device using the microfluidic system.

### BACKGROUND

Microfluidic systems, such as micro-total analysis systems, and miniaturized point-of-care devices have gained increasing interest over the last decades. Such systems typically may involve benefits including rapid analysis response at the point of sampling and enabling analysis even away from analytical laboratories or hospitals. Microfluidic systems and point-of-care devices may be used in analysis of biological samples or liquids, such as blood samples, including whole blood. Sample may be mixed with buffers and then analysed using capillary-driven microfluidic systems.

Such systems may be used when measurement and control of volumes is needed, for example in blood cell differentiation or counting, where the volume of the blood sample processed must be accurately known. In a system where a relatively large blood sample (>10 μl) is added, it may not be desirable to process the entire sample of blood since only a minute quantity (<10 μl) is needed to get accurate statistics on the blood cell make-up or distribution. Therefore, the sampling systems need to measure a known quantity of blood from the sample for processing.

However, precise volume metering in systems using capillary action is challenging, since existing systems of such type generally do not allow for shutting or closing off a fluid stream once it has started. Therefore, a precisely metered volume of fluid cannot simply be extracted from a sample by shutting off the flow to prevent too much sample from flowing into the system. Thus, there exists a need for an improved microfluidic system providing a sample having a precisely metered volume.

Further, it is typically difficult and problematic to reach high dilution ratios and sufficiently dilute sample with buffer in capillary driven systems.

There is, thus, a need to provide microfluidic systems with reduced problems associated with sample metering and sample dilution, not just concerning blood samples, but many type of liquid samples or samples in solution.

### SUMMARY

It is an object to, at least partly, mitigate, alleviate, or eliminate one or more of the above-identified deficiencies in the art and disadvantages singly or in any combination and solve at least one above indicated problem.

According to a first aspect of the present disclosure, there is provided a microfluidic system for diluting a sample liquid having a predetermined volume. The system comprises: a sample inlet configured to receive a sample liquid; a first sample channel connecting the sample inlet and a first valve and being configured to draw sample liquid, by capillary action, from the sample inlet to the first valve; a second sample channel connecting the first valve and a capillary pump and being configured to draw sample liquid, by capillary action, from the first valve to the capillary pump; a sample metering channel having a first end connected to a second valve and a second end connected to a third valve, wherein the first valve is connected to the sample metering channel between the first end and the second end, the sample metering channel being configured to draw sample liquid, by capillary action, from the first valve to the second valve and to the third valve, thereby filling the sample metering channel with sample liquid having a predetermined sample volume corresponding to a volume of the sample metering channel, or corresponding to a combined volume of the sample metering channel and sample liquid present in the first valve; wherein the capillary pump is configured to empty the first sample channel and the second sample channel subsequent to the filling of the sample metering channel. The system further comprises: a buffer inlet configured to receive a buffer liquid; a first buffer channel connecting the buffer inlet and the second valve and being configured to draw buffer liquid, by capillary action, from the buffer inlet to the second valve, and to open the second valve; an outlet channel connected to the third valve and being configured to draw liquid, by capillary action, from the third valve; a second buffer channel connecting the second valve and the third valve and being configured to draw buffer liquid, by capillary action, from the second valve to the third valve, and to open the third valve, whereby a liquid path comprising the first buffer channel and the sample metering channel is opened up; thereby allowing sample liquid present in the sample metering channel to be replaced by buffer liquid from the first buffer channel and flow into the outlet channel together with buffer liquid from the second buffer channel.

The microfluidic system may be configured such that, during flow of buffer from the second valve to the third valve, in the second buffer channel, before the third valve is reached by buffer and opened, sample remains in the sample metering channel.

By means of the present microfluidic system, a high dilution ratio (i.e., a volumetric ratio of buffer liquid to sample liquid) of the liquid flowing into the outlet channel is allowed. In particular, the present microfluidic system allows for a high dilution ratio in a single dilution step (i.e., the mixing occurring at and/or after the third valve). Further, the present microfluidic system allows for a reduction of a number of valves and/or components needed for diluting sample liquid with buffer liquid. Hence, a less complex microfluidic system capable of diluting sample liquid with buffer liquid is allowed. Furthermore, a total resistance (i.e., flow resistance) of the present microfluidic system can be reduced. This may, in turn, allow for a time needed to empty the metered volume of the sample (i.e., the sample liquid present in the sample metering channel) to be low.

Each of the second valve and the third valve may be a capillary trigger valve, wherein the second valve may have a closed position configured to stop a flow of liquid within the sample metering channel at the first end, and an open position configured to allow liquid communication between the sample metering channel and the first and second buffer channels; and wherein the third capillary trigger valve may have a closed position configured to stop a flow of liquid within the sample metering channel at the second end, and an open position configured to allow liquid communication between the sample metering channel, and the second buffer channel and the outlet channel.

The capillary pump may be further configured to: empty the first valve of sample liquid, or allow sample liquid to remain in the first valve.

In case the capillary pump is configured to empty the first valve, a more precise predetermined sample volume corresponding to the volume of the sample metering channel may be achieved. Further, smaller sample volumes may be achieved if the first valve is emptied of sample liquid, which may be desirable.

In case the capillary pump is configured to allow sample liquid to remain in the first valve, more sample liquid from the inlet is going to the metered volume and less sample liquid is wasted to the capillary pump.

The sample inlet may be connected to a sample reservoir. The sample reservoir may be releasably connected to the sample inlet. In such case, the sample reservoir may form part of a separate, possibly portable, entity. For example, the sample reservoir may be part of device configured to collect the sample, whereby the sample is drawn into the sample inlet from the sample reservoir upon being connected to the sample inlet. This may be advantageous since the device holding the sample reservoir may be disposable, whereby other parts of the microfluidic system may be reused.

The outlet channel may be further connected to a capillary pump.

An associated advantage is that an improved extraction of a combined flow of sample liquid mixed with buffer liquid from the third valve may be allowed.

The first valve may be a one-way valve. Put differently, the first valve may allow liquid to flow from the first sample channel and the second sample channel to the sample metering channel, and the first valve may prohibit liquid to flow from the sample metering channel to the first sample channel and/or to the second sample channel.

An associated advantage is that an improved isolation (i.e., isolation from the first sample channel and/or the second sample channel) of sample liquid present in the sample metering channel may be allowed. This may, in turn, allow for an improved metering of the volume of the sample liquid in the sample metering channel. An improved and/or more precisely metered volume of the sample liquid in the sample metering channel may allow for a more precisely metered volume of sample liquid flowing through the third valve into the outlet channel.

The sample metering channel and the second buffer channel may be configured to allow a dilution ratio r for sample liquid flowing into the outlet channel, via the third valve, together with buffer liquid from the second buffer channel, to be defined by:

$$r = \frac{{R}_{channel 114 + 115}}{{R}_{channel 112}}$$

The dilution ratio is a volumetric dilution ratio. In the equation above, R_{channel114+115} may be a flow resistance of the sample metering channel and R_{channel112} may be a flow resistance of the second buffer channel.

The sample metering channel may comprise a first portion having the first end connected to the second valve, and a second portion having the second end connected to the third valve.

According to a second aspect there is provided a method for diluting a sample liquid having a predetermined volume. The method comprising: adding sample liquid to a sample inlet; drawing sample liquid, by capillary action, from the sample inlet to a first valve via a first sample channel; drawing sample liquid, by capillary action, from the first valve to a capillary pump, via a second sample channel; drawing sample liquid, by capillary action, from the first valve to a second valve and to a third valve via a sample metering channel having a first end connected to the second valve and a second end connected to the third valve, wherein the first valve is connected to the sample metering channel between the first end and the second end, thereby filling the sample metering channel with sample liquid having a predetermined sample volume corresponding to a volume of the sample metering channel or corresponding to a combined volume of the sample metering channel and sample liquid present in the first valve; emptying the first sample channel and the second sample channel subsequent to the filling of the sample metering channel, using the capillary pump; adding buffer liquid to a buffer inlet; drawing buffer liquid, by capillary action, from the buffer inlet to the second valve, and opening the second valve; drawing buffer liquid, by capillary action, from the second valve to the third valve via the second buffer channel, and opening the third valve; replacing sample liquid present in the sample metering channel by buffer liquid from the first buffer channel and flowing the sample liquid into the outlet channel together with buffer liquid from the second buffer channel, whereby diluted sample liquid is presented in the outlet channel.

The emptying of the first sample channel and the second sample channel subsequent to the filling of the sample metering channel, using the capillary pump, may further comprise emptying the first valve of sample liquid, or allowing sample liquid to remain in the first valve.

The above-mentioned features of the first aspect, when applicable, apply to this second aspect as well. In order to avoid undue repetition, reference is made to the above.

According to a third aspect there is provided a diagnostic device comprising the microfluidic system of the first aspect.

The diagnostic device may be configured to analyse the sample liquid.

The above-mentioned features of the first aspect and the second aspect, when applicable, apply to this third aspect as well. In order to avoid undue repetition, reference is made to the above.

### BRIEF DESCRIPTION OF THE DRAWINGS

The above and other aspects of the present disclosure will now be described in more detail, with reference to appended drawings showing variants of the present disclosure. The figures should not be considered limiting the present disclosure to the specific variant; instead, they are used for explaining and understanding the present disclosure.

As illustrated in the figures, sizes of components, such as channels, and regions, may be exaggerated for illustrative purposes and, thus, be provided to illustrate the general structures of variants of the present disclosure. Like reference numerals refer to like elements throughout.

FIG. 1 illustrates a microfluidic system.

FIGS. 2A-2H illustrate a working principle of the microfluidic system of FIG. 1.

FIG. 3 is a block diagram of a method for diluting a sample liquid having a predetermined volume.

### DETAILED DESCRIPTION

The present disclosure will now be described more fully hereinafter with reference to the accompanying drawings, in which variants of presently disclosed concepts are shown. The described concepts may, however, be implemented in many different forms and should not be construed as limited to the variants set forth herein; rather, these variants are provided for thoroughness and completeness, and fully convey the scope of the present disclosure to the skilled person.

In the following, liquid may flow through channels and reach certain positions at different times or order within the microfluidic system. Flow rates of liquids may be controlled in different manners in order for the fluid to reach the positions at the described times or order. A capillary-driven flow of a fluid requires one or more contacting surfaces that the fluid can wet. For example, surfaces comprising glass or silica may be used for capillary-driven flows of aqueous liquids. Further, for example, suitable polymers with hydrophilic properties, either inherent to the polymer or by modification, including for example chemical modification or coating, may promote or enhance capillary driven flows. Capillary-driven flows, in addition to being dependent on materials of surfaces, is dependent on the liquid flowing. Attractive forces between the liquid and surfaces of channels have effect on a capillary-driven flow.

The skilled person is aware that capillary-driven flows may be controlled, for example, by adapting dimensions, including length, width, and depth, of the channels and/or by adapting the flow resistances of the channels, and/or by adapting capillary driving forces or pressures. For example, the flow resistance of a channel may be controlled by adapting a cross-sectional area of the channel and/or the length of the channel. The flow resistance of a channel may, as indicated above, further be dependent on properties of the liquid, for example its dynamic viscosity. Additionally, or alternatively, the flow rate (the volumetric flow rate) may be adapted by using flow resistors, for example flow resistors in a flow path of the liquid. A flow resistor may be a channel with a defined flow resistance in a flow path of the liquid. To provide desired capillary forces, dimensions of flow channels may be selected dependent on, for example, the liquid and properties of the liquid and/or material and/or properties of walls of the channels.

Herein, as liquid, for example sample liquid or buffer liquid, is described as being eg. drawn into, introduced to, filled into, or received by eg. channels, valves or reservoirs of the microfluidic system, it shall be understood that gaseous medium, such as air or other type of gas or gas mixture, that is replaced by the liquid may be allowed to be output, or vented, from the channel, valve or reservoir being filled with liquid. The gaseous medium may, thus and for example be directly vented from the microfluidic system or be vented into a connecting channel, valve or reservoir. The gaseous medium that is replaced by the liquid may be vented from the microfluidic system through openings or vents, for example and suitably communicating with ambient air. Thereby, gaseous medium in a channel, a valve or a reservoir that is replaced by liquid may be allowed to leave the microfluidic system. It shall also be understood that when liquid is output or removed from eg. a channel, a vent or a reservoir, and if it is not replaced with liquid, it may be allowed to be replaced with gaseous medium, for example air, which may be introduced in replacement of the liquid via a connecting channel, valve, or reservoir and the gaseous medium that is replacing the liquid may be introduced or input to the microfluidic system through openings or vents, suitably and for example communicating with ambient air. It shall be realised, that the communication does not have to be with ambient air, it may, for example, be with other type of gas or gas mixture than ambient air, and the gas or gas mixture may be provided from eg. a vessel or a compartment, or similar, holding the gas or gas mixture. It shall be understood from examples and variants of aspects herein that suitable vents or openings may be positioned within the microfluidic system. For example, such vents or openings for allowing gas or gas mixture to enter and/or leave may be provided or positioned in connection with or connected to one or more of the capillary pump, the sample inlet, the sample reservoir, the buffer inlet, the buffer reservoir, the outlet, the outlet channel, the further capillary pump, the first valve, the second valve, and the third valve. The microfluidic system may comprise one or more vents or venting means capable of allowing gaseous medium to be input and/or output from the microfluidic system.

It shall also be realised that the one or more of the capillary pump, the sample inlet, the sample reservoir etc. must not be provided with an opening or a vent, it may be sufficient that the microfluidic system is connected to or be in fluidic connection with an opening or vent, or with a further system that is connected to a vent or opening. To mention some examples, the outlet channel and/or the further outlet channel, may be in fluidic connection with a downstream opening or vent, or other means of communication with eg. ambient air. For example, an outlet channel may end in or mouth into ambient air. Alternatively, or in addition, for example one or more of the buffer channel, the buffer reservoir, the sample channel and the sample reservoir may be in fluidic connection with an upstream opening, or other means of communication with eg. ambient air.

The vent, or venting means, may be any type of suitable venting means. For example, the vent may be an opening or, for example, a piece of tubing or channel, or a valve.

One or more of the capillary pump, the sample inlet, the sample reservoir, the buffer inlet, the buffer reservoir, the outlet, the outlet channel, the further capillary pump, the first valve, the second valve, and the third valve may be provided with or be connected to one or more opening or vent, wherein the one or more opening or vent may allow air to be input or output from the respective capillary pump, the sample inlet, the sample reservoir, the buffer inlet, the buffer reservoir, the outlet, the outlet channel, the further capillary pump, the first valve, the second valve, and the third valve.

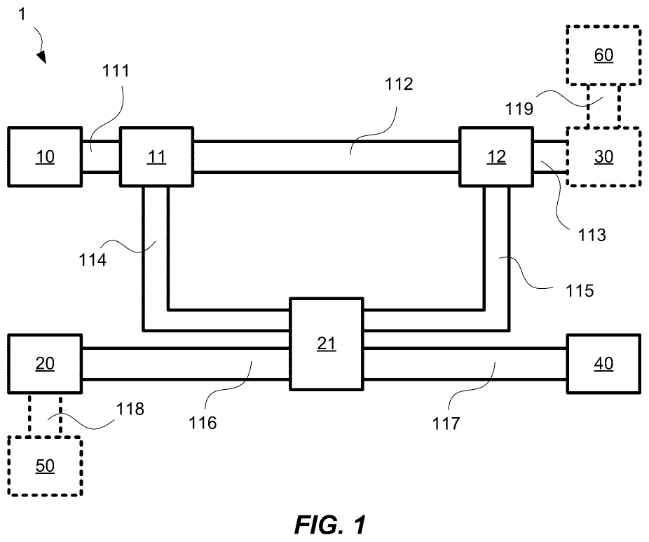

FIG. 1 illustrates a microfluidic system 1 for diluting a sample liquid having a predetermined volume. The microfluidic system 1 may form part of a diagnostic device (not illustrated). Put differently, the present disclosure may be implemented in a diagnostic device comprising the microfluidic system 1 illustrated in FIG. 1 and discussed below. The diagnostic device may be configured to analyse the sample liquid. Hence, the diagnostic device may comprise further features configured to perform ananalysis of the sample liquid. For example, the diagnostic device may be configured to perform chemical analysis and/or image-based analysis of the sample liquid.

As illustrated in the example of FIG. 1, the microfluidic system 1 comprises a sample inlet 20, a buffer inlet 10, a first sample channel 116, a second sample channel 117, a sample metering channel 114, 115, a first buffer channel 111, a second buffer channel 112, an outlet channel 113, a first valve 21, a second valve 11, a third valve 12, and a capillary pump 40. As illustrated in the example of FIG. 1, the microfluidic system 1 may further comprise one or more of an outlet 30, a sample reservoir 50, a further capillary pump 60, a third sample channel 118, and a further outlet channel 119. It is to be understood that at least the first sample channel 116, the second sample channel 117, the sample metering channel 114, 115, and the second buffer channel 112 are capillary channels. In addition, the first buffer channel 111, the outlet channel 113, and the further outlet channel 119 may be capillary channels. A capillary channel may be a channel capable of providing a capillary-driven flow of a liquid. It is also to be understood that other channels and components of the system may be capillary channels and/or other types of channels depending on the specific implementation of the present disclosure. Although a capillary channel may be capable of providing a capillary-driven flow of a liquid, it is not excluded that other types of transport or forwarding of liquids may be used with the channels. For example, pressure-assisted flows may be employed.

The sample inlet 20 is configured to receive a sample liquid. The sample may be a histology sample. The sample may, e.g., be blood or saliva.

The sample inlet 20 may, for example, comprise an opening, such as being a compartment open to the environment or having an orifice, and thereby allowed to receive a sample liquid by sample liquid being placed, for example as a droplet, in contact with the sample inlet 20. Thereafter the sample liquid may enter the first sample channel by capillary action. As illustrated in the example of FIG. 1, the sample inlet 20 may be connected to the sample reservoir 50. The sample reservoir 50 may, as is exemplified in FIG. 1, be connected to the sample inlet 20 via the third sample channel 118. The sample reservoir 50 may comprise a breakable container configured to hold the sample liquid. Upon breaking the breakable container of the sample reservoir, the sample liquid may be allowed to escape the breakable container, whereby the sample inlet 20 receives the sample liquid. The sample reservoir 50 may be releasably connected to the sample inlet 20. In such case, the sample reservoir 50 may form part of a separate, possibly portable, entity. For example, the sample reservoir 50 may be part of device configured to collect the sample, whereby the sample is drawn into the sample inlet 20 from the sample reservoir 50 upon being connected to the sample inlet 20. The device of which the sample reservoir 50 forms part may be disposable, and other parts of the microfluidic system 1 may be reused.

The first sample channel 116 connects the sample inlet 20 and the first valve 21. The first sample channel 116 is configured to draw sample liquid, by capillary action, from the sample inlet 20 to the first valve 21. The second sample channel 117 connects the first valve 21 and the capillary pump 40. The second sample channel 117 is configured to draw sample liquid, by capillary action, from the first valve 21 to the capillary pump 40.

The sample metering channel 114, 115 has a first end connected to the second valve 11. The sample metering channel 114, 115 may comprise a first portion 114 having the first end connected to the second valve 11. The second valve 11 may be a capillary trigger valve. The second valve 11 may have a closed position (or state) configured to stop a flow of liquid within the sample metering channel 114, 115 at the first end. The second valve 11 may have an open position (or state) configured to allow liquid communication between the sample metering channel 114, 115 and the first and second buffer channels 111, 112. The sample metering channel 114, 115 has a second end connected to the third valve 12. The sample metering channel 114, 115 may have a second portion 115 having the second end connected to the third valve 12. The third valve 12 may be a capillary trigger valve. The third valve 12 may have a closed position (or state) configured to stop a flow of liquid within the sample metering channel 114, 115 at the second end. The third valve 12 may have an open position (or state) configured to allow liquid communication between the sample metering channel 114, 115, and the second buffer channel 112 and the outlet channel 113. A capillary trigger valve may be understood as a microfluidic structure comprising a fluidic junction of channels where a liquid flow from a first channel may be stopped at the junction and later may be triggered to flow by a liquid flow reaching the capillary trigger valve or junction from a second channel (the second channel being different from the first channel) connected to the junction. The liquid flow from the first channel may be stopped at the junction for example, by having its outlet of the junction on the side wall of the second channel, which second channel may be deeper than the first channel at the junction.

The first valve 21 is connected to the sample metering channel 114, 115 between the first end and the second end. The first valve 21 may be a one-way valve. Put differently, the first valve 21 may allow liquid to flow from the first sample channel 116 and/or the second sample channel 117 to the sample metering channel 114, 115, and the first valve 21 may prohibit liquid to flow from the sample metering channel 114, 115 to the first sample channel 116 and/or to the second sample channel 117. Hence, the first valve 21 being a one-way type of valve may allow liquid to enter the sample metering channel 114,115 when liquid is present in the first and second sample channels 116, 117, but may block liquid flow from the sample metering channel 114,115 toward the first and second sample channels 116,117 when they are empty of liquid.

The sample metering channel 114, 115 is configured to draw sample liquid, by capillary action, from the first valve 21 to the second valve 11 and to the third valve 12, thereby filling the sample metering channel 114, 115 with sample liquid having a predetermined sample volume. The predetermined sample volume corresponds to a volume of the sample metering channel 114, 115, or to a combined volume of the sample metering channel 114, 115 and sample liquid present in the first valve 21.

The capillary pump 40 is configured to empty the first sample channel 116 and the second sample channel 117 subsequent to the filling of the sample metering channel 114, 115. The capillary pump 40, or the capillary pump 40 and the first valve 21, may be further configured to empty the first valve 21 of sample liquid, or to allow sample liquid to remain in the first valve 21. The capillary pump 40 may be a paper pump. Further, the capillary pump may be another suitable type of capillary pump. For example, the capillary pump may comprise or consist of a capillary channel. The first sample channel 116, the second sample channel 117, the sample metering channel 114, 115, and the capillary pump 40, and, optionally, the first valve 21, may be configured such that the capillary pump 40 may be allowed to empty the first sample channel 116 and the second sample channel 117, and possibly the first valve 21, without being allowed to empty the sample metering channel 114, 115. Put differently, a capillary pressure of the capillary pump 40 and dimensions of first sample channel 116, dimensions of the second sample channel 117, and dimensions of the sample metering channel 114, 115, and retention capillary pressures at the second and third valves 11, 12 are configured such that the capillary pump 40 may empty the first and second sample channels 116, 117 but not empty (i.e., create a receding liquid interface) the sample metering channel 114, 115. The capillary pump 40, such as a paper pump or a capillary pump comprising a capillary channel, may have a sufficient volume to allow sample liquid comprised by the first sample channel 116 and the second sample channel 117, and optionally, the first valve 21 to be absorbed by the capillary pump 40. In addition, the capillary pump 40 may further allow absorbing sample liquid remaining in the sample inlet 20, and, yet further and in addition, may allow absorbing sample liquid remaining in the sample the sample reservoir 50 and third sample channel 118.

The capillary pump 40 being configured to empty the first sample channel 116 and the second sample channel 117 subsequent to the filling of the sample metering channel 114, 115, may be achieved or realised in a plurality of different ways. For example, the capillary pump 40 may be connected to the second sample channel 117 subsequent to the filling of the sample metering channel 114, 115; or a sufficient amount of sample liquid may be present or may be introduced to the sample inlet 20 and/or the sample reservoir 50, such that the capillary pump 40 can only empty the first sample channel 116 and the second sample channel 117 after the filling of the sample metering channel 114, 115. Further examples include that the first sample channel 116, the second sample channel 117, the sample metering channel 114, 115, and the capillary pump 40 may be designed or selected to provide suitable resistance and suction pressure. Further examples include providing the second channel with a sufficient length to time the emptying of the first sample channel 116 and the second sample channel 117 subsequent to the filling of the sample metering channel 114, 115. It shall be appreciated and realised that further examples may be provided.

The buffer inlet 10 is configured to receive a buffer liquid. The buffer inlet 10 may be configured to receive buffer liquid from a buffer reservoir (not illustrated). The buffer reservoir may comprise a breakable container configured to hold buffer liquid. Upon breaking the breakable container of the buffer reservoir, buffer liquid may be allowed to escape the breakable container, whereby the buffer inlet 10 receives buffer liquid. The buffer inlet 10 may be configured to receive the buffer liquid directly using, for example, a pipette.

The first buffer channel 111 connects the buffer inlet 10 and the second valve 11. The first buffer channel 111 is configured to draw buffer liquid, by capillary action, from the buffer inlet 10 to the second valve 11, and to open the second valve 11. The second valve 11 may be configured to open in response to receiving buffer liquid from the first buffer channel 111.

The outlet channel 113 is connected to the third valve 12. The outlet channel 113 is configured to draw liquid, by capillary action, from the third valve 12. The outlet channel 113 may be connected to the outlet 30. The outlet channel 113 may be further connected to the further capillary pump 60. The further capillary pump 60 may be a paper pump. The further capillary pump 60 may, as exemplified in FIG. 1, be connected to the outlet channel 113 via the further outlet channel 119. In such case, the further outlet channel 119 may be connected to the outlet 30. Alternatively, the further outlet channel 119 may be connected directly to the outlet channel 113. In such case, the microfluidic system 1 may not comprise the outlet 30. It shall be realized and appreciated, that liquid flowing through the outlet channel 113 may proceed to further manipulation or treatment, for example analysis, or may be forwarded to an additional system.

The second buffer channel 112 connects the second valve 11 and the third valve 12. The second buffer channel 112 is configured to draw buffer liquid, by capillary action, from the second valve 11 to the third valve 12, and to open the third valve 12. The first buffer channel 111, the second buffer channel 112, the sample metering channel 114, 115, the third valve 12, and the first valve 21 may be further configured such that, when the second valve 11 is opened, or triggered, and third valve 12 is closed, in relation to liquid from the sample metering channel 114, 115, sample liquid may not be drawn from the sample metering channel 114, 115 via the third valve 12 to the first buffer channel 111 and/or the second buffer channel 112, or via the first valve 21 to the first sample channel 116 and/or the second sample channel 117.

The third valve 12 may be configured to open in response to receiving buffer liquid from the second buffer channel 112. When the third valve 12 is opened a liquid path comprising the first buffer channel 111 and the sample metering channel 114, 115 is opened up, thereby allowing sample liquid present in the sample metering channel 114, 115 to be replaced by buffer liquid from the first buffer channel 111 and flow into the outlet channel 113 together with buffer liquid from the second buffer channel 112.

The sample metering channel 114, 115 and the second buffer channel 112 may be configured to allow a dilution ratio r for sample liquid flowing into the outlet channel 113, via the third valve 12, together with buffer liquid from the second buffer channel 112, to be defined by:

r=R_{channel114+115}/R_{channel112}.

The dilution ratio is a volumetric dilution ratio. Here, R_{channel114+115} may be a flow resistance of the sample metering channel 114, 115 and R_{channel112} may be a flow resistance of the second buffer channel 112. A resistance (i.e., a flow resistance) of the sample metering channel 114, 115 may be configured such that the second valve 11 and the third valve 12 may function properly. Put differently, the resistance of the sample metering channel 114, 115 may be configured to be sufficiently high for having functional stopping of the flows at the second and third valves 11, 12. Since the second valve 11 and the third valve 12 may be configured to be opened by receiving liquid (e.g., buffer liquid) from the first buffer channel 111 and the second buffer channel 112, respectively, the second and third valves 11, 12 may not be configured to stop liquid flows from those channels 111, 112. Hence, functionalities of the second valve 11 and the third valve 12 (i.e., stopping liquid flow from the sample metering channel 114, 115) may be substantially independent of a flow rate in the first and second buffer channels 111, 112. Therefore, a resistance (i.e., a flow resistance) of the second buffer channel 112 may be configured to be low and may thereby lead to a high dilution ratio between buffer liquid and sample liquid flowing through the third valve 12 to the output channel.

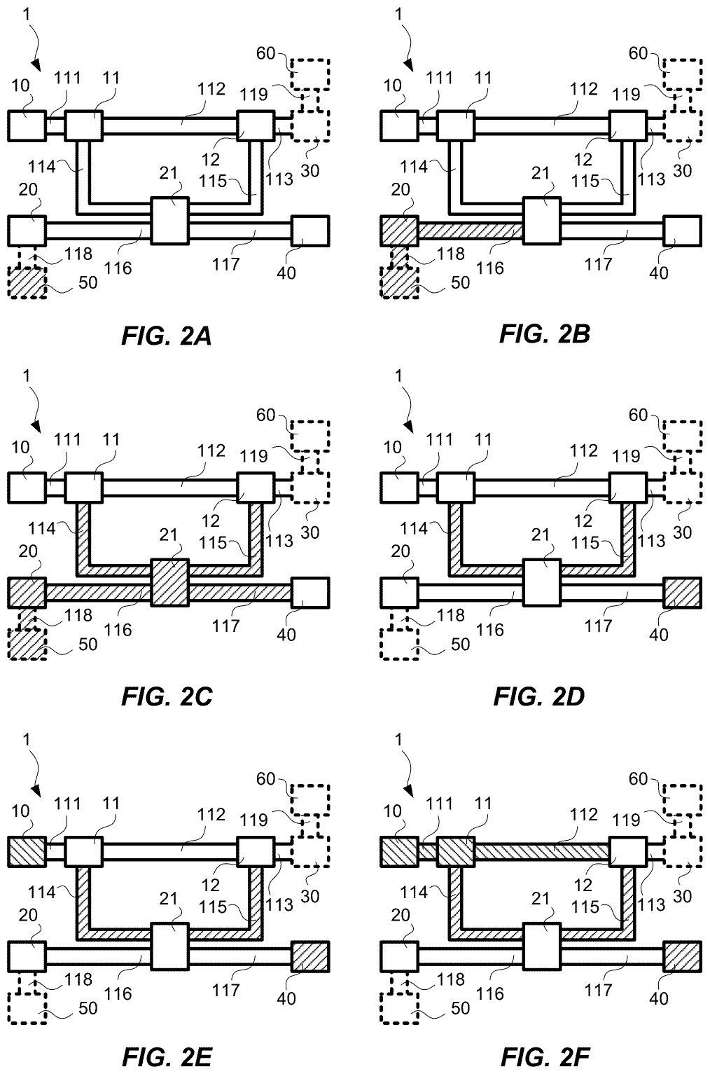

A working principle of the microfluidic system 1 of FIG. 1 will now be described with reference to FIG. 2A-2G.

In FIG. 2A, sample liquid is present in a sample reservoir 50. In the example of FIG. 2A-FIG. 2H, sample liquid is added to a sample inlet 20 by connecting the sample reservoir 50 to the sample inlet 20 via a third sample channel 118. It is however to be understood that sample liquid may be received by the sample inlet 20 in different manners. For example, sample liquid may be added directly to the sample inlet 20 by using, e.g., a pipette.

In FIG. 2B, sample liquid has been received by the sample inlet 20, and sample liquid is drawn, by capillary action, from the sample inlet 20 to a first valve 21 via a first sample channel 116.

In FIG. 2C, sample liquid has filled the first valve 21, and sample liquid is drawn, by capillary action, from the first valve to a capillary pump 40 via a second sample channel 117. Further, sample liquid is drawn, by capillary action, from the first valve 21 to a second valve 11 and a third valve 12 via a sample metering channel 114, 115. The second valve 11 and the third valve 12 are in a closed position (or state), and thereby stops sample liquid from flowing through the second valve 11 and the third valve 12, respectively. This may be achieved, for example, through use of a capillary trigger valve. As is illustrated in FIG. 2C, the second valve 11 may be connected to a first end of the sample metering channel 114, 115. The sample metering channel 114, 115 may comprise a first portion 114 having the first end connected to the second valve 11. Hence, sample liquid may be drawn, by capillary action, from the first valve 21 to the second valve 11 via the first portion 114 of the sample metering channel 114, 115. As is further illustrated in FIG. 2C, the third valve 12 may be connected to a second end of the sample metering channel 114, 115. The sample metering channel 114, 115 may comprise a second portion 115 having the second end connected to the third valve 12. Hence, sample liquid may be drawn, by capillary action, from the first valve 21 to the third valve 12 via the second portion 115 of the sample metering channel 114, 115.

At a point when the sample metering channel 114, 115 has been filled, the capillary pump 40 empties the first sample channel 116 and the second sample channel 117, which is illustrated in FIG. 2D. As is further illustrated in FIG. 2D, the capillary pump 40 may empty one or more of the sample reservoir 50, the third sample channel 118, and the sample inlet 20. It is however to be understood that the sample reservoir 50 and/or the third sample channel 118 may be emptied in different manners. For example, in case the sample reservoir 50 is removably connected to the sample inlet 20, the sample reservoir 50 may be disconnected from the sample inlet 20, thereby prohibiting further sample liquid to flow from the sample reservoir 50 to the sample inlet 20. In FIG. 2D, sample liquid having a predetermined volume is isolated in the sample metering channel 114, 115. The predetermined volume corresponds to a volume of the sample metering channel 114, 115. The capillary pump 40 may, as illustrated in FIG. 2D, empty the first valve 21. It is however to be understood that the capillary pump 40 may be configured such that sample liquid is allowed to remain in the first valve 21. In such case, the predetermined volume corresponds to a combined volume of the sample metering channel 114, 115 and sample liquid present in the first valve 21. It is to be understood that sample liquid is shown in FIG. 2D-FIG. 2H as being present in the capillary pump 40 for illustrative purposes, since sample liquid may be transported to a further system and/or may be discarded.

Subsequent to sample liquid having the predetermined volume being metered, buffer liquid is added to a buffer inlet 10 as illustrated in FIG. 2E. The buffer inlet 10 may receive buffer liquid from a buffer reservoir (not illustrated) similarly as the sample inlet 20 may receive sample liquid from a sample reservoir 50. Alternatively, the buffer inlet 10 may receive buffer liquid directly, for example by using a pipette. Buffer liquid is drawn, by capillary action, from the buffer inlet 10 to the second valve 11 via a first buffer channel 111. Upon receiving buffer liquid from the first buffer channel 111, the second valve 11 is opened (i.e., changed to its opened position or state). As is illustrated in FIG. 2F, buffer liquid may not enter the sample metering channel 114, 115 via the second valve 11, since the third valve 12 is still in its closed position. In addition, the first valve 21 may have a closed state and block liquid flow from the sample metering channel 114,115 toward the first and second sample channels 116,117 when they are empty of liquid.

Further, as is illustrated in FIG. 2F, buffer liquid is drawn from the second valve 11 to the third valve 12 via a second buffer channel 112. The first buffer channel 111, the second buffer channel 112, the sample metering channel 114, 115, the third valve 12, and the first valve 21 may be further configured such that, when the second valve 11 is opened, or triggered, and third valve 12 is closed, in relation to liquid from the sample metering channel 114, 115, sample liquid may not be drawn from the sample metering channel 114, 115 via the third valve 12 to the first buffer channel 111 and/or the second buffer channel 112, or via the first valve 21 to the first sample channel 116 and/or the second sample channel 117. Upon receiving buffer liquid from the second buffer channel 112, the third valve 12 is opened (i.e., changed to its opened position or state). At a point when the second valve 11 and the third valve 12 are in their open positions, a liquid path comprising the first buffer channel 111 and the sample metering channel 114, 115 is opened up. This, since both the second valve 11 and the third valve 12 are in their open positions. Sample liquid present in the sample metering channel 114, 115 is then allowed to be replaced with buffer liquid from the first buffer channel 111 via the first valve 11. This is illustrated in FIG. 2G, where sample liquid in the first portion 114 of the sample metering channel 114, 115 has been replaced with buffer liquid from the first buffer channel 111. Sample liquid present in the sample metering channel 114, 115 is then allowed to flow into an outlet channel 113 via the third valve 12 together with buffer liquid from the second buffer channel 112. The first valve 21 allows liquid to pass between the first portion 114 and the second portion 115 of the sample metering channel 114, 115. In FIG. 2H, sample liquid present in sample metering channel 114, 115 has been replaced by buffer liquid from the first buffer channel 111 and has flown to the outlet channel 113 via the third valve 12 together with buffer liquid from the second buffer channel 112. Thus, the sample liquid having the predetermined volume (i.e., sample liquid previously present in the sample metering channel 114, 115) is thereby diluted by buffer liquid from the second buffer channel 112.

As is illustrated in FIG. 2G and FIG. 2H, the diluted sample liquid may flow to an outlet 30 connected to the outlet channel 113. A further capillary pump 60 may be connected to the outlet 30 via a further outlet channel 119. In such case, the diluted sample liquid may be drawn to the further capillary pump 60. It is further to be understood that the diluted sample liquid may be analysed, for example, by transporting the diluted sample liquid to an additional system (not illustrated) as discussed previously.

Hence, the present microfluidic system 1, a high dilution ratio (i.e., a volumetric ratio of buffer liquid to sample liquid) of the diluted sample liquid flowing into the outlet channel 113 is allowed. In particular, the present microfluidic system 1 allows for a high dilution ratio in a single dilution step (i.e., the dilution occurring at and/or downstream of the third valve 12). Further, the microfluidic system 1 may be implemented using a small number of valves and/or components compared to prior art system. Hence, a less complex microfluidic system 1 capable of diluting sample liquid is allowed. Furthermore, a total resistance (i.e., flow resistance) of the microfluidic system 1 can be reduced. This may, in turn, allow for a time needed to empty the metered volume of the sample (i.e., the sample liquid isolated in the sample metering channel 114, 115) to be low.

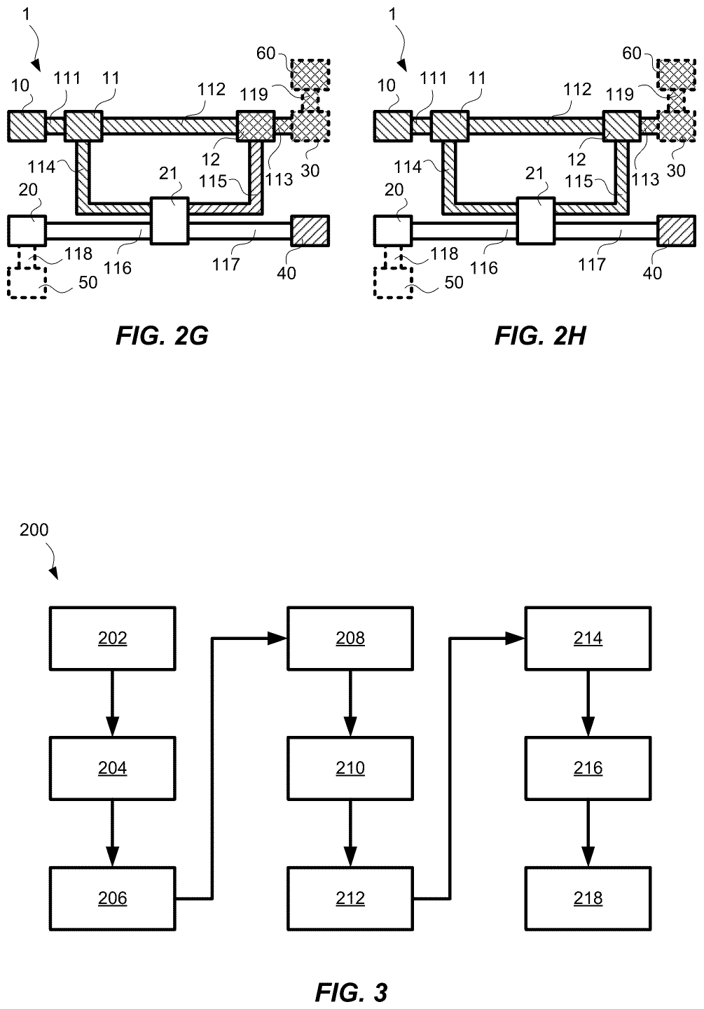

FIG. 3 is a block diagram of a method 200 for diluting a sample liquid having a predetermined volume. The method 200 may be implemented using a microfluidic system 1 similar to that illustrated in FIG. 1 and discussed above.

The method 200 comprises adding 202 sample liquid to a sample inlet 20.

The method 200 further comprises drawing 204 sample liquid, by capillary action, from the sample inlet 20 to a first valve 21 via a first sample channel 116.

The method 200 further comprises drawing 206 sample liquid, by capillary action, from the first valve 21 to a capillary pump 40, via a second sample channel 117

The method 200 further comprises drawing 208 sample liquid, by capillary action, from the first valve 21 to a second valve 11 and to a third valve 12 via a sample metering channel 114, 115 having a first end connected to the second valve 11 and a second end connected to the third valve 12, wherein the first valve 21 is connected to the sample metering channel 114, 115 between the first end and the second end, thereby filling the sample metering channel 114, 115 with sample liquid having a predetermined sample volume corresponding to a volume of the sample metering channel 114, 115 or corresponding to a combined volume of the sample metering channel 114, 115 and sample liquid present in the first valve 21.

The method 200 further comprises emptying 210 the first sample channel 116 and the second sample channel 117 subsequent to the filling of the sample metering channel 114, 115, using the capillary pump 40.

The method 200 further comprises adding 212 buffer liquid to a buffer inlet 10. Buffer liquid may be added 212 to the buffer inlet 10 subsequent to the emptying 210 of the first sample channel 116 and the second sample channel 117, and, optionally, the first valve 21.

The emptying the first sample channel 116 and the second sample channel 117 subsequent to the filling of the sample metering channel 114, 115, using the capillary pump 40, may further comprise emptying the first valve 21 of sample liquid, or allowing sample liquid to remain in the first valve 21.

The method 200 further comprises drawing 214 buffer liquid, by capillary action, from the buffer inlet 10 to the second valve 11, and opening the second valve 11.

The method 200 further comprises drawing 216 buffer liquid, by capillary action, from the second valve 11 to the third valve 12 via the second buffer channel 112, and opening the third valve 12.

The method 200 further comprises replacing 218 sample liquid present in the sample metering channel 114, 115 by buffer liquid from the first buffer channel 111 and flowing the sample liquid into the outlet channel 113 together with buffer liquid from the second buffer channel 112, whereby diluted sample liquid is presented in the outlet channel 113.

What is claimed is:

1. A microfluidic system for diluting a sample liquid having a predetermined volume, the system comprising:
a sample inlet configured to receive a sample liquid;
a first sample channel connecting the sample inlet and a first valve and being configured to draw sample liquid, by capillary action, from the sample inlet to the first valve;
a second sample channel connecting the first valve and a capillary pump and being configured to draw sample liquid, by capillary action, from the first valve to the capillary pump;
a sample metering channel having a first end connected to a second valve (11) and a second end connected to a third valve, wherein the first valve is connected to the sample metering channel between the first end and the second end, the sample metering channel being configured to draw sample liquid, by capillary action, from the first valve to the second valve and to the third valve, thereby filling the sample metering channel with sample liquid having a predetermined sample volume corresponding to a volume of the sample metering channel, or corresponding to a combined volume of the sample metering channel and sample liquid present in the first valve,
wherein the capillary pump is configured to empty the first sample channel and the second sample channel subsequent to the filling of the sample metering channel;
the system further comprising:
a buffer inlet configured to receive a buffer liquid;
a first buffer channel connecting the buffer inlet and the second valve and being configured to draw buffer liquid, by capillary action, from the buffer inlet to the second valve, and to open the second valve;
an outlet channel connected to the third valve and being configured to draw liquid, by capillary action, from the third valve;
a second buffer channel connecting the second valve and the third valve and being configured to draw buffer liquid, by capillary action, from the second valve to the third valve, and to open the third valve, whereby a liquid path comprising the first buffer channel and the sample metering channel is opened up; thereby allowing sample liquid present in the sample metering channel to be replaced by buffer liquid from the first buffer channel and flow into the outlet channel together with buffer liquid from the second buffer channel.

2. The microfluidic system according to claim 1,
wherein each of the second valve and the third valve is a capillary trigger valve, wherein the second valve has a closed position configured to stop a flow of liquid within the sample metering channel at the first end, and an open position configured to allow liquid communication between the sample metering channel and the first and second buffer channels; and
wherein the third capillary trigger valve has a closed position configured to stop a flow of liquid within the sample metering channel at the second end, and an open position configured to allow liquid communication between the sample metering channel, and the second buffer channel and the outlet channel.

3. The microfluidic system according to claim 1, wherein the capillary pump is further configured to:
empty the first valve of sample liquid, or
allow sample liquid to remain in the first valve.

4. The microfluidic system according to claim 1, wherein the sample inlet is connected to a sample reservoir.

5. The microfluidic system according to claim 1, wherein the outlet channel is further connected to a further capillary pump.

6. The microfluidic system according to claim 1, wherein the first valve is a one-way valve.

7. The microfluidic system according to claim 1, wherein the sample metering channel and the second buffer channel are configured to allow a dilution ratio r for sample liquid flowing into the outlet channel, via the third valve, together with buffer liquid from the second buffer channel, to be defined by:
$$r = \frac{{R}_{channel 114 + 115}}{{R}_{channel 112}}$$
wherein R_{channel114+115} refers to a flow resistance of the sample metering channel and R_{channel112} refers a flow resistance of the second buffer channel.

8. The microfluidic system according to claim 1, wherein the sample metering channel comprises a first portion having the first end connected to the second valve, and a second portion having the second end connected to the third valve.

9. A method for diluting a sample liquid having a predetermined volume, the method comprising:
adding sample liquid to a sample inlet;
drawing sample liquid, by capillary action, from the sample inlet to a first valve via a first sample channel;
drawing sample liquid, by capillary action, from the first valve to a capillary pump, via a second sample channel;
drawing sample liquid, by capillary action, from the first valve to a second valve and to a third valve via a sample metering channel having a first end connected to the second valve and a second end connected to the third valve, wherein the first valve is connected to the sample metering channel between the first end and the second end, thereby filling the sample metering channel with sample liquid having a predetermined sample volume corresponding to a volume of the sample metering channel or corresponding to a combined volume of the sample metering channel and sample liquid present in the first valve;
emptying the first sample channel and the second sample channel subsequent to the filling of the sample metering channel, using the capillary pump;
adding buffer liquid to a buffer inlet;
drawing buffer liquid, by capillary action, from the buffer inlet to the second valve, and opening the second valve;
drawing buffer liquid, by capillary action, from the second valve to the third valve via the second buffer channel, and opening the third valve;
replacing sample liquid present in the sample metering channel by buffer liquid from the first buffer channel and flowing the sample liquid into the outlet channel together with buffer liquid from the second buffer channel, whereby diluted sample liquid is presented in the outlet channel.

10. A diagnostic device comprising the microfluidic system of claim 1.

11. The diagnostic device according to claim 10, wherein the diagnostic device is configured to analyse the sample liquid.
